(19) United States
(12) Patent Application Publication
(10) Pub. No.: US 2018/0049265 A1
(43) Pub. Date: Feb. 15, 2018

(54) COMMUNICATION SYSTEM IN SUPPORT OF MULTI-CONNECTIVITY AND CONNECTING METHOD THEREOF

(71) Applicant: Institute For Information Industry, Taipei (TW)

(72) Inventors: Shu-Tsz LIU, Taipei City (TW); Feng-Ming Yang, Taipei City (TW); Yi-Hsueh TSAI, New Taipei City (TW)

(21) Appl. No.: 15/675,536

(22) Filed: Aug. 11, 2017

Related U.S. Application Data
(60) Provisional application No. 62/373,969, filed on Aug. 11, 2016.

(51) Int. Cl. H04W 76/02

(52) U.S. Cl. CPC H04W 76/025; H04W 84/042

(57) ABSTRACT

Embodiments of the present invention relate to a communication system in support of multi-connectivity and a connecting method thereof. In the embodiments, the communication system includes a core network, a master base station, a secondary base station, and a user equipment, wherein the master base station and the secondary base station belong to different wireless communication systems. The secondary base station includes a secondary base station centralized unit and at least one secondary base station distributed unit. The master base station coordinates, with the secondary base station centralized unit, how the user equipment connects with the at least one secondary base station distributed unit, according to a measurement report provided by the user equipment. Therefore, the user equipment connects with not only the master base station but also the at least one secondary base station distributed unit at the same time to support multi-connectivity.

### PRIORITY

This application claims priority to U.S. Provisional Patent Application No. 62/373,969 filed on Aug. 11, 2016, which is hereby incorporated by reference in its entirety.

### FIELD

Embodiments of the present invention relates to a communication system. More particularly, embodiments of the present invention relate to a communication system in support of multi-connectivity and a connecting method thereof.

### BACKGROUND

As the 4^{th} Generation (4G) Wireless Communication Systems achieve its expected goal, standardization institutes including the International Telecommunication Union (ITU), the 3^{rd} Generation Partnership Project (3GPP) and the 5^{th} Generation Infrastructure Public-Private Partnership (5G PPP) are all actively participating in formulation of standards of the next generation of wireless communication systems (aka. the 5^{th} Generation Wireless Communication Systems). As compared with the 4^{th} Generation Wireless Communication Systems, the standardization institutes commonly consider that the 5^{th} Generation Wireless Communication Systems have the following advantages: higher transmission speed, better transmission quality, higher signal coverage rate, more widespread networking environments, and so on.

Whether the 5^{th} Generation Wireless Communication Systems support multi-connectivity has been preliminarily discussed by the standardization institutes. Multi-connectivity generally means that a single user equipment can connect with a plurality of base stations at the same time to improve the communication capability and/or the communication quality thereof. However, implementation of the multi-connectivity is just a concept at present, and there is still no final scheme on how it shall be implemented. One of the reasons why there is still no final scheme on how it shall be implemented is that there are still disputes about the role to be played by the 5^{th} Generation Wireless Communication Systems in the future. In other words, the standardization institutes have not reached an agreement on whether the 5^{th} Generation Wireless Communication Systems will completely replace the 4^{th} Generation Wireless Communication Systems or just coexist with the 4^{th} Generation Wireless Communication Systems.

Accordingly, it is an important objective in the art to provide an implementation architecture and a connecting method suitable for multi-connectivity in the 5^{th} Generation Wireless Communication Systems.

### SUMMARY

The disclosure includes a communication system in support of multi-connectivity. The communication system may comprise a core network, a user equipment, a secondary base station and a master base station. The user equipment may be configured to provide a measurement report. The secondary base station may comprise a secondary base station centralized unit and at least one secondary base station distributed unit. The secondary base station centralized unit may connect to the at least one secondary base station distributed unit, and may be configured to manage the at least one secondary base station distributed unit. The master base station may connect to the core network, the user equipment and the secondary base station centralized unit, and may be configured to coordinate, with the secondary base station centralized unit, how the user equipment connects with the at least one secondary base station distributed unit, according to the measurement report.

The disclosure also includes a connecting method for use in a communication system in support of multi-connectivity. The communication system may comprise a core network, a user equipment, a secondary base station and a master base station. The secondary base station may comprise at least one secondary base station distributed unit and a secondary base station centralized unit that connects to the at least one secondary base station distributed unit and is configured to manage the at least one secondary base station distributed unit. The master base station may connect to the core network, the user equipment and the secondary base station centralized unit. The connecting method may comprise:

providing a measurement report by the user equipment; and

the master base station coordinating, with the secondary base station centralized unit, how the user equipment connects with the at least one secondary base station distributed unit, according to the measurement report.

In further disclosed embodiments, multi-connectivity can be achieved in cases where the 5^{th} Generation Wireless Communication Systems coexists with the 4^{th} Generation Wireless Communication Systems and the master base station and the secondary base station belong to wireless communication systems of two different generations respectively. The secondary base station may comprise a secondary base station centralized unit (an upper-layer management unit) and one or more secondary base station distributed units (lower-layer communication/connecting units). For example, the secondary base station centralized unit may be a baseband unit (BBU), while the secondary base station distributed unit may be a remote radio head (RRH). The user equipment can connect with not only the master base station but also with at least one secondary base station distributed unit included in the secondary base station to support multi-connectivity.

In still further disclosed embodiments, the master base station needs not to coordinate with each secondary base station distributed unit for connections between the user equipment and the secondary base station distributed units. Instead, the master base station may coordinate with only the secondary base station centralized unit included in the secondary base station, and then the secondary base station centralized unit instructs the secondary base station distributed units included in the secondary base station according to the coordination result to complete one or more connections between the user equipment and the secondary base station distributed units. Thereby, in the embodiments of the present invention, the number of signaling transmissions between the master base station and the secondary base station is reduced, thus improving the efficiency and reducing the load.

In additional disclosed embodiments, the user equipment may connect with the master base station and the at least one secondary base station distributed unit at the same time (i.e., in support of the multi-connectivity). Therefore, even when a certain connection fails, other connections can still provide the necessary communication function no matter during the process that the user equipment hands over from one master base station to another master base station or during the process that the user equipment switches between connections with the secondary base station distributed units. This can improve the communication reliability of the user equipment by effectively reducing the possibility of communication outage for the user equipment.

The summary of the invention summarizes certain core concepts and encompasses the problems to be solved, the means to be adopted and the effects that can be achieved by the present invention so as to provide a basic understanding of the present invention by a person having ordinary skill in the art. However, it shall be understood that, the summary of the invention is not intended to summarize all embodiments of the present invention, but presents the core concepts of the present invention in a simplified form as an introduction to the following detailed description.

### BRIEF DESCRIPTION OF THE DRAWINGS

FIG. 1 illustrates an architecture of a communication system in support of multi-connectivity according to one or more embodiments of the present invention;

FIG. 2 illustrates an operation mode of the communication system shown in FIG. 1 according to one or more embodiments of the present invention;

FIG. 3 illustrates another operation mode of the communication system shown in FIG. 1 according to one or more embodiments of the present invention; and

FIG. 4 illustrates a connecting method for use in a communication system in support of multi-connectivity according to one or more embodiments of the present invention.

### DETAILED DESCRIPTION

Embodiments described hereinafter are not intended to limit the present invention to any specific examples, environments, applications, structures, process flows or steps described in these embodiments. In the attached drawings, elements unrelated to the present invention are omitted from depiction; and dimensions of individual elements and dimensional relationships among the individual elements in the attached drawings are illustrated only as exemplary examples, but not to limit the present invention. Unless otherwise stated, the same or similar symbols correspond to the same or similar elements in the following description.

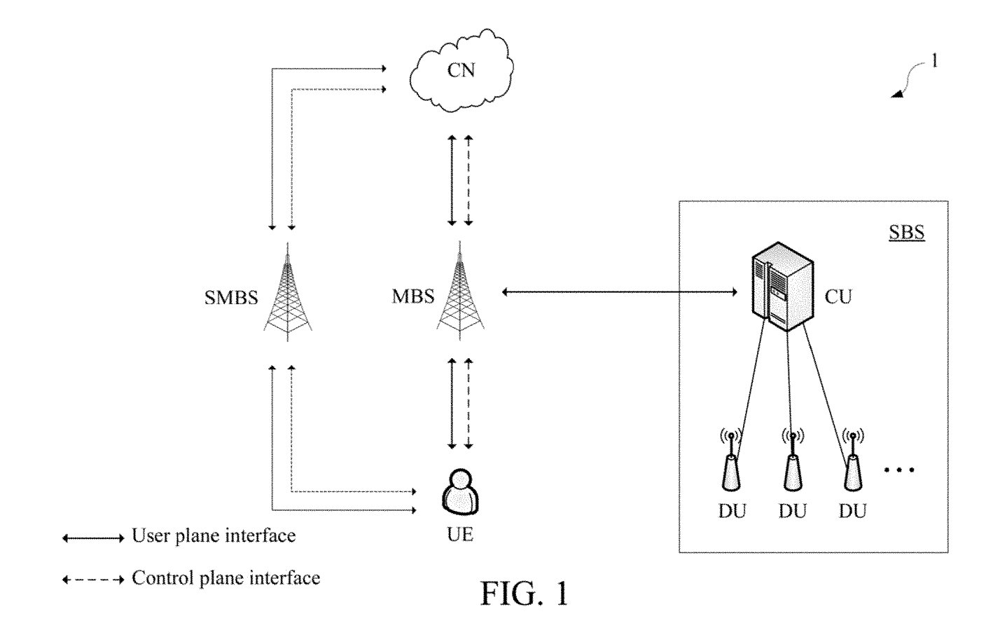

FIG. 1 illustrates an architecture of a communication system in support of multi-connectivity according to one or more embodiments of the present invention.

However, what shown in FIG. 1 is only intended to illustrate the embodiments of the present invention but not to limit the present invention. Referring to FIG. 1, the communication system 1 may comprise a core network CN, a user equipment UE, a secondary base station SBS and a master base station MBS.

As a large-scale data center network in the communication system 1, the core network CN may generally comprise such devices and units as an access switch to provide different services, e.g., confirming accesses of the user equipment to network services, providing message exchanges between a plurality of sub-networks and etc. The core network CN may also be configured to manage base stations to which it connects. In some embodiments, the core network CN may be an Evolved Packet Core Network (EPC) derived from the 4^{th} Generation Wireless Communication Systems. In some other embodiments, the core network CN may be a Next Generation Core Network (5GC) dedicated to the future 5^{th} Generation Wireless Communication Systems.

The user equipment UE may be any of various devices directly used by a user for communication in the communication technical field, for example but not limited to, a handheld phone, a notebook computer, a desktop computer, an IoT (Internet of Things)-enabled device, an IoV (Internet of Vehicles)-enabled vehicle, or some other device with networking functions.

The secondary base station SBS may be a New Radio (NR) base station (aka. gNB) dedicated to the future 5^{th} Generation Wireless Communication Systems. The secondary base station SBS may comprise a secondary base station centralized unit CU acting as an upper-layer management unit and at least one secondary base station distributed unit DU acting as a lower-layer communication/connecting unit. The secondary base station centralized unit CU may connect to the at least one secondary base station distributed unit DU, and manage the at least one secondary base station distributed unit DU. The secondary base station centralized unit CU mainly comprises non-real-time wireless high-level protocol functions, and also supports deployment of some core network function lower-layer and marginal application services, while the secondary base station distributed units DU mainly processes the physical-layer and real time functions. For example, the secondary base station centralized unit CU may be a Baseband Unit (BBU), while the secondary base station distributed unit DU may be a Remote Radio Head (RRH). The secondary base station centralized unit CU and the secondary base station distributed units DU may connect with each other through a logical interface (e.g., an F1 logical interface), and a plurality of secondary base stations SBS may connect with each other through a logical interface (e.g., an Xn logical interface). In some embodiments, the secondary base station centralized unit CU and the secondary base station distributed units DU may physically collocated on a single device or machine. In some embodiments, the secondary base station centralized unit CU and the secondary base station distributed units DU may be configured separately on different devices or machines.

The master base station MBS may be an Evolved Universal Terrestrial Radio Access (E-UTRA) base station (aka. eNB) derived from the 4^{th} Generation Wireless Communication Systems. The master base station MBS has a coordination function and is in charge of coordination with the secondary base station SBS. The master base station MBS may connect to the core network CN, the user equipment UE and the secondary base station centralized unit CU.

As shown in FIG. 1, the communication system 1 may control connections between the user equipment and different network layers via a Control plane interface, including but not limited to: controlling to select different communication resources, making a connection request to the server, performing a handover procedure for connection with the base station, and so on. As an example, if the core network CN is an EPC, then the master base station MBS may connect with the core network CN and the user equipment UE respectively via an S1-C logical interface on the Control plane so that the Mobility Management Entity (MME) included in the core network CN controls the master base station MBS and the user equipment UE. As another example, if the core network CN is a 5GC, then the master base station MBS may connect with the core network CN and the user equipment UE respectively via the NG-C logical interface on the control interface so that the Core Access and Mobility Management Function (AMF) included in the core network CN controls the master base station MBS and the user equipment UE.

The communication system 1 may also transmit various pieces of data (e.g., user data, and etc) via the User plane. As an example, if the core network CN is an EPC, then the master base station MBS may connect with the core network CN and the user equipment UE respectively via an S1-U logical interface on the User plane so that the Serving Gateway (SGW) included in the core network CN manages transmissions of the various pieces of data, for example but not limited to, routing and forwarding of the user data. As another example, if the core network CN is a 5GC, then the master base station MBS may connect with the core network CN and the user equipment UE respectively via an NG-U logical interface on the Control plane so that the User plane function included in the core network CN manages transmissions of the various pieces of data, for example but not limited to, routing and forwarding of the user data.

As shown in FIG. 1, the communication system 1 may connect the master base station MBS and the secondary base station SBS via the User plane interface so that data can be transmitted between the master base station MBS and the secondary base station SBS. As an example, if the core network CN is an EPC, then the communication system 1 may connect the master base station MBS and the secondary base station SBS via an X2-U logical interface on the User plane. As another example, if the core network CN is an 5GC, then the communication system 1 may connect the master base station MBS and the secondary base station SBS via an Xn-U logical interface on the User plane. In some embodiments, the communication system 1 may also connect the master base station MBS and the secondary base station SBS via the Control plane interface instead of the User plane interface so as to control the secondary base station SBS via the master base station MBS. As an example, if the core network CN is an EPC, then the communication system 1 may connect the master base station MBS and the secondary base station SBS via an X2-C logical interface on the Control plane. As another example, if the core network CN is a 5GC, then the communication system 1 may connect the master base station MBS and the secondary base station SBS via an Xn-C logical interface on the User plane.

In some embodiments, the communication system 1 may connect the core network CN and the secondary base station SBS via a User plane interface so that data (not shown) can be transmitted between the core network CN and the secondary base station SBS. As an example, if the core network CN is an EPC, then the communication system 1 may connect the master base station MBS and the secondary base station SBS via an S1-U logical interface on the User plane. As another example, if the core network CN is a 5GC, then the communication system 1 may connect the master base station MBS and the secondary base station SBS via an NG-U logical interface on the User plane.

Referring to FIG. 1, in some embodiments, the communication system 1 may further comprise a source master base station SMBS. The source master base station SMBS connects with the core network CN and the user equipment UE respectively before the user equipment UE connects with the master base station MBS. Then the user equipment UE changes to connect with the master base station MBS instead through a handover procedure. The way in which the source master base station SMBS connects with the core network CN and the user equipment UE may be the same as the way in which the master base station MBS connects with the core network CN and the user equipment UE.

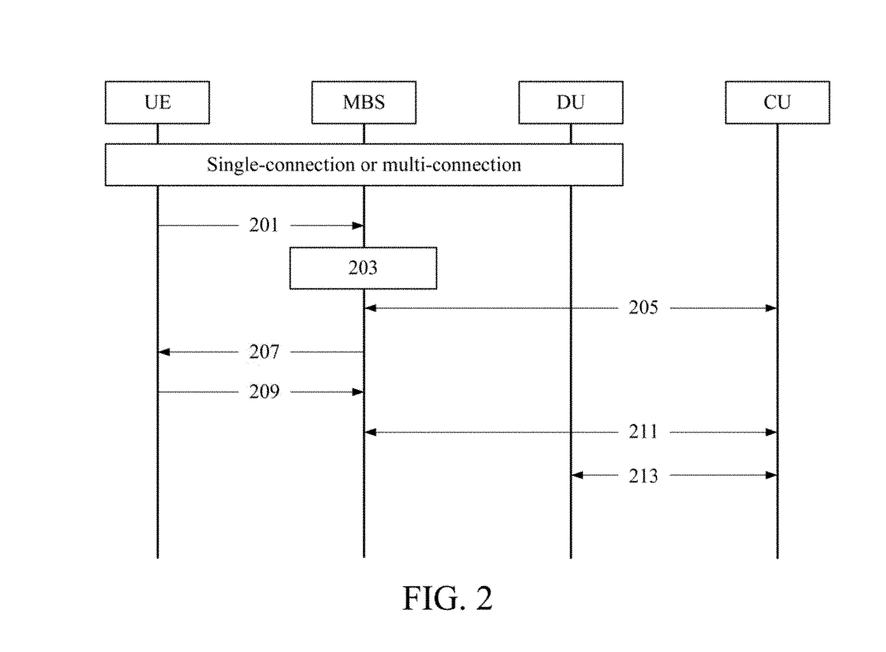

FIG. 2 illustrates an operation mode of the communication system shown in FIG. 1 according to one or more embodiments of the present invention. However, what shown in FIG. 2 is only intended to illustrate the embodiments of the present invention but not to limit the present invention. The operation mode illustrated in FIG. 2 is based on an assumption that the master base station MBS has already connected with the user equipment UE and the core network CN or that the user equipment UE has already been handed over from the source master base station SMBS to the master base station MBS.

Referring to FIG. 1 and FIG. 2, the user equipment UE may be in a single-connection or multi-connection status before the user equipment UE transmits a measurement report to the master base station MBS (labeled as 201). The single-connection means that the user equipment UE currently connects with only the master base station MBS, while the multi-connection means that the user equipment UE currently not only connects with the master base station MBS but also with one or more secondary base station distributed units DU. The measurement report transmitted by the user equipment UE may comprise various pieces of information necessary for connecting the user equipment UE and the secondary base station distributed units DU, for example but not limited to, all pieces of information of the secondary base station distributed units DU, various pieces of connection information, and/or various pieces of cell information. The connection information may include beam information, while the cell information may include ID, measurement values, settings, . . . , or the like.

In some embodiments, before the user equipment UE transmits a measurement report to the master base station MBS (labeled as 201), the master base station MBS may first transmit a connection capability information enquiry signal to the user equipment UE to confirm whether the user equipment UE has the capability to connect with the master base station MBS and the secondary base station SBS at the same time. The user equipment UE may transmit a connection capability acknowledgement signal to the master base station MBS to inform the master base station MBS of whether the user equipment UE has this connection capability. If the user equipment UE has this connection capability, then the measurement report may be transmitted to the master base station MBS.

After receiving the measurement report transmitted by the user equipment UE, the master base station MBS may coordinate, with the secondary base station centralized unit CU, how the user equipment UE connects with the at least one secondary base station distributed unit DU, according to the measurement report. For example, the coordination between the master base station MBS and the secondary base station centralized unit CU may comprise at least one of: adding one or more connections between the user equipment UE and the at least one secondary base station distributed unit DU; releasing one or more connections between the user equipment UE and the at least one secondary base station distributed unit DU; and adjusting one or more connections between the user equipment UE and the at least one secondary base station distributed unit DU.

For example, the master base station MBS may select from the at least one secondary base station distributed unit DU a secondary base station distributed unit DU to connect with the user equipment UE (labeled as 203). In some embodiments where each secondary base station distributed unit DU provides only one beam, the master base station MBS may select one or more secondary base station distributed units DU to connect with the user equipment UE. In some embodiments where each secondary base station distributed unit DU can provide one or more beams, the master base station MBS may select one or more beams provided by the at least one secondary base station distributed units DU to connect with the user equipment UE.

After the secondary base station distributed unit(s) DU to connect with the user equipment UE has been selected, the master base station MBS may coordinate with the secondary base station centralized unit CU according to related information of the selected secondary base station distributed unit(s) DU (labeled as 205). For example, the master base station MBS may first transmit a request (e.g., a request for adding, releasing and/or adjusting one or more of the secondary base station distributed units DU) to the secondary base station centralized unit CU, and provide information such as the master cell group configuration and the connection capability of the user equipment UE to the secondary base station centralized unit CU. In response to the request from the master base station MBS, the secondary base station centralized unit CU may transmit back an acknowledgement and provide information such as protocol data units (PDUs) of the RRC of the secondary base station SBS to the master base station MBS.

After receiving the acknowledgement transmitted by the secondary base station centralized unit CU, the master base station MBS may reconfigure the Radio Resource Control (RRC) of the user equipment UE according to related information of the selected secondary base station distributed unit(s) DU (e.g., ID and setting parameters of the secondary base station distributed unit DU as well as PDUs of the RRC of the secondary base station SBS) (labeled as 207), and the user equipment UE will notice the master base station MBS when the reconfiguration is completed (labeled as 209). Once the user equipment has been reconfigured, the connection between the user equipment UE and the selected secondary base station distributed unit(s) DU can be reconfigured by the master base station MBS and the secondary base station centralized unit CU (labeled as 211), and then the secondary base station centralized unit CU instructs the secondary base station distributed unit DU to connect with the user equipment UE (labeled as 213).

Depending on the coordination between the master base station MSB and the secondary base station centralized unit CU (i.e., adding, releasing, and/or adjusting one or more secondary base station distributed units DU), the user equipment UE may be in a single-connection or a multi-connection status after the secondary base station centralized unit CU has instructed the secondary base station distributed unit DU to connect with the user equipment (labeled as 213). The single-connection means that the user equipment UE currently connects with only the master base station MBS, while the multi-connection means that the user equipment UE currently not only connects with the master base station MBS but also with one or more secondary base station distributed units DU.

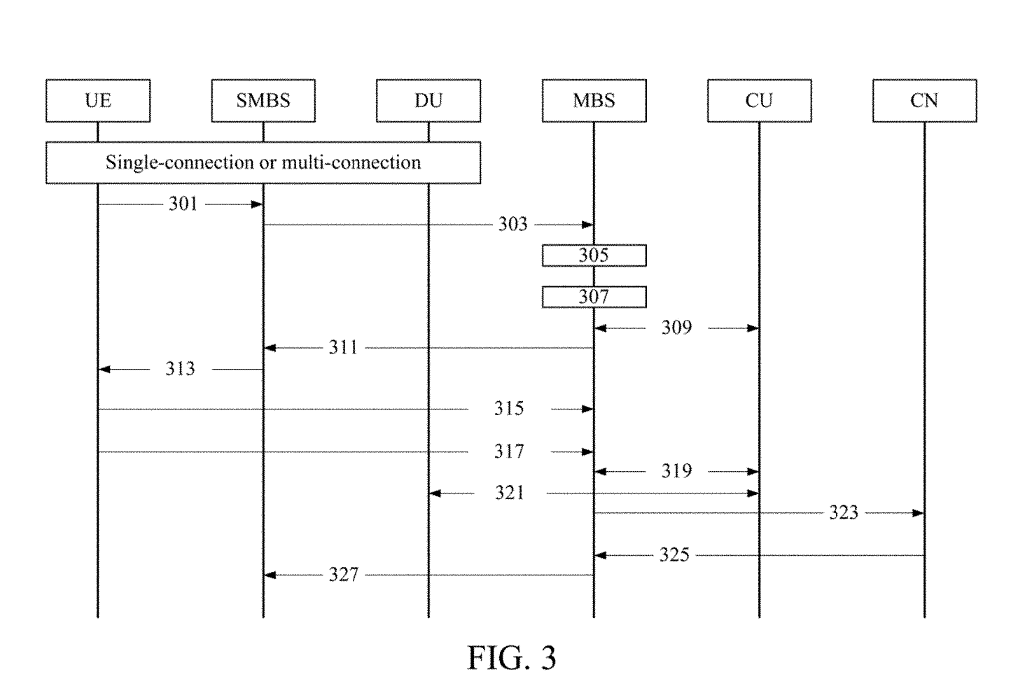

FIG. 3 illustrates another operation mode of the communication system 1 shown in FIG. 1 according to one or more embodiments of the present invention. However, what shown in FIG. 3 is only intended to illustrate the embodiments of the present invention but not to limit the present invention. The operation mode illustrated in FIG. 3 is based on a process in which the user equipment UE hands over from a source master base station SMBS to the master base station MBS. In other words, as shown in FIG. 3, during the process in which the user equipment UE hands over from the source master base station SMBS to the master base station MBS, the master base station MBS may coordinate, with the secondary base station centralized unit CU, how the user equipment UE connects with the secondary base station distributed unit DU, according to the measurement report provided by the user equipment UE.

Referring to FIG. 1 and FIG. 3, the user equipment UE may be in a single-connection or multi-connection status before the user equipment UE transmits a measurement report to the source master base station SMBS (labeled as 301). The single-connection means that the user equipment UE currently connects with only the source master base station SMBS, while the multi-connection means that the user equipment UE currently not only connects with the source master base station SMBS but also with one or more secondary base station distributed units DU. The measurement report transmitted by the user equipment UE may comprise various pieces of information necessary for connecting the user equipment UE and the secondary base station distributed units DU, for example but not limited to, all pieces of information of the secondary base station distributed units DU, various pieces of connection information, and/or various pieces of cell information. The connection information may include beam information, while the cell information may include ID, measurement values, settings, . . . , or the like.

In some embodiments, before the user equipment UE transmits a measurement report to the source master base station SMBS (labeled as 301), the source master base station SMBS may first transmit a connection capability information enquiry signal to the user equipment UE to confirm whether the user equipment UE has the capability to connect with the master base station MBS and the secondary base station SBS at the same time. The user equipment UE may transmit a connection capability acknowledgement signal to the source master base station SMBS to inform the source master base station SMBS of whether the user equipment UE has this connection capability. If the user equipment UE has this connection capability, then the measurement report may be transmitted to the source master base station SMBS.

After receiving the measurement report transmitted by the user equipment UE, the source master base station SMBS may transmit a handover request to the master base station MBS (labeled as 303). The handover request may be appended with the measurement report. Then the master base station MBS may decide whether to accept the handover request from the source master base station SMBS (labeled as 305).

If the master base station MBS accepts the handover request from the source master base station SMBS, then the master base station MBS may coordinate, with the secondary base station centralized unit CU, how the user equipment UE connects with the at least one secondary base station distributed unit DU, according to the measurement report. For example, the coordination between the master base station MBS and the secondary base station centralized unit CU may comprise at least one of: adding one or more connections between the user equipment UE and the at least one secondary base station distributed unit DU; releasing one or more connections between the user equipment UE and the at least one secondary base station distributed unit DU; and adjusting one or more connections between the user equipment UE and the at least one secondary base station distributed unit DU.

For example, the master base station MBS may select from the at least one secondary base station distributed unit DU a secondary base station distributed unit DU to connect with the user equipment UE (labeled as 307). In some embodiments where each secondary base station distributed unit DU provides only one beam, the master base station MBS may select one or more secondary base station distributed units DU to connect with the user equipment UE. In some embodiments where each secondary base station distributed unit DU can provide one or more beams, the master base station MBS may select one or more beams provided by the at least one secondary base station distributed units DU to connect with the user equipment UE.

After the secondary base station distributed unit(s) DU to connect with the user equipment UE has been selected, the master base station MBS may coordinate with the secondary base station centralized unit CU according to related information of the selected secondary base station distributed unit(s) DU (labeled as 309). For example, the master base station MBS may first transmit a request (e.g., a request for adding, releasing and/or adjusting one or more of the secondary base station distributed units DU) to the secondary base station centralized unit CU, and provide information such as the master cell group configuration and the connection capability of the user equipment UE to the secondary base station centralized unit CU. In response to the request from the master base station MBS, the secondary base station centralized unit CU may transmit back an acknowledgement and provide information such as protocol data units (PDUs) of the RRC of the secondary base station SBS to the master base station MBS.

After receiving the acknowledgement transmitted by the secondary base station centralized unit CU, the master base station MBS may transmit a handover request acknowledgement back to the source master base station SMBS (labeled as 311). The handover request acknowledgement may comprise related information of the selected secondary base station distributed unit(s) DU (e.g., ID and setting parameters of the secondary base station distributed unit DU as well as PDUs of the RRC of the secondary base station SBS). Then, the source master base station SMBS may reconfigure the Radio Resource Control (RRC) of the user equipment UE according to related information of the selected secondary base station distributed unit(s) DU (e.g., ID and setting parameters thereof) (labeled as 313). Next, the user equipment UE may access the master base station MBS (labeled as 315), and notice the master base station MBS when the reconfiguration is completed (labeled as 317). Once the user equipment has been reconfigured, the connection between the user equipment UE and the selected secondary base station distributed unit(s) DU can be reconfigured by the master base station MBS and the secondary base station centralized unit CU (labeled as 319), and then the secondary base station centralized unit CU instructs the secondary base station distributed unit DU to connect with the user equipment UE (labeled as 321).

Because the user equipment UE is to hand over from the source master base station SMBS to the master base station MBS, the core network CN switches a path of the source master base station SMBS into a path of the master base station MBS. Therefore, the master base station SMBS may transmit a path switching request to the core network CN (labeled as 323), and the core network CN may transmit a path switching request acknowledgement back in response to the path switching request (labeled as 325). After receiving the path switching request acknowledgement transmitted by the core network CN, the master base station MBS may instruct the source master base station SMBS to complete the user equipment background release (labeled as 327).

Depending on the coordination between the master base station MSB and the secondary base station centralized unit CU (i.e., adding, releasing, and/or adjusting one or more secondary base station distributed units DU), the user equipment UE may be in a single-connection or a multi-connection status after the user equipment background release is completed by the source master base station SMBS (labeled as 327). The single-connection means that the user equipment UE currently connects with only the master base station MBS, while the multi-connection means that the user equipment UE currently not only connects with the master base station MBS but also with one or more secondary base station distributed units DU.

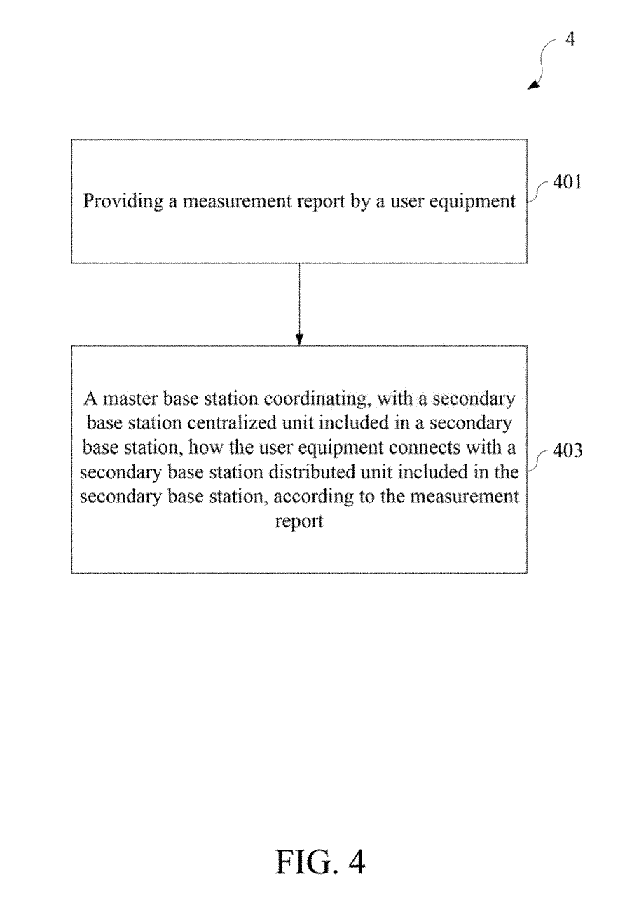

FIG. 4 illustrates a connecting method for use in a communication system in support of multi-connectivity according to one or more embodiments of the present invention. However, what shown in FIG. 4 is only intended to illustrate the embodiments of the present invention but not to limit the present invention. Referring to FIG. 4, the connecting method 4 may comprise:

providing a measurement report by a user equipment (labeled as 401); and

a master base station coordinating, with a secondary base station centralized unit included in a secondary base station, how the user equipment connects with a secondary base station distributed unit included in the secondary base station, according to the measurement report (labeled as 403).

The connecting method 4 may be applied to a communication system in support of multi-connectivity. The communication system may comprise a core network, the user equipment, the secondary base station and the master base station. The secondary base station may include the secondary base station centralized unit which connects to the secondary base station distributed unit and is configured to manage the secondary base station distributed unit. The master base station may connect to the core network, the user equipment and the secondary base station centralized unit.

In some embodiments, the master base station may be an Evolved Universal Terrestrial Radio Access (E-UTRA) base station, and the secondary base station may be a New Radio (NR) base station.

In some embodiments, the core network may be an Evolved Packet Core Network or a Next Generation Core Network.

In some embodiments, the coordination between the master base station and the secondary base station centralized unit may comprise at least one of:

adding one or more connections between the user equipment and the secondary base station distributed unit;

releasing one or more connections between the user equipment and the secondary base station distributed unit; and

adjusting one or more connections between the user equipment and the secondary base station distributed unit.

In some embodiments, the communication system may further comprise a source master base station, and the master base station coordinates, with the secondary base station centralized unit, how the user equipment connects with the secondary base station distributed unit, according to the measurement report during a process that the user equipment hands over from the source master base station to the master base station. In those embodiments, optionally, the connecting method 4 may further comprise:

the core network switches a path of the source master base station into a path of the master base station during the process that the user equipment hands over from the source master base station to the master base station.

In some embodiments, the connecting method 4 may be applied to the communication system 1 to complete all the aforesaid operations of the communication system 1. Because all corresponding steps of the connecting method 4 can be readily known by a person having ordinary skill in the art from the above description of the communication system 1, they will not be further detailed herein.

In embodiments of the present invention, multi-connectivity can be achieved in cases where the 5^{th} Generation Wireless Communication Systems coexists with the 4^{th} Generation Wireless Communication Systems, and the master base station and the secondary base station belong to wireless communication systems of two different generations respectively. The secondary base station may comprise a secondary base station centralized unit (an upper-layer management unit) and one or more secondary base station distributed units (lower-layer communication/connecting units). For example, the secondary base station centralized unit may be a baseband unit (BBU), while the secondary base station distributed unit may be a remote radio head (RRH). The user equipment can connect with not only the master base station but also with at least one secondary base station distributed unit included in the secondary base station to support multi-connectivity.

In embodiments of the present invention, the master base station needs not to coordinate with each secondary base station distributed unit for connections between the user equipment and the secondary base station distributed units. Instead, the master base station may coordinate with only the secondary base station centralized unit in the secondary base station, and then the secondary base station centralized unit instructs the secondary base station distributed units included in the secondary base station according to the coordination result to complete one or more connections between the user equipment and the secondary base station distributed units. Thereby, in the embodiments of the present invention, the number of signaling transmissions between the master base station and the secondary base station is reduced, thus improving the efficiency and reducing the load.

In embodiments of the present invention, the user equipment may connect with the master base station and the at least one secondary base station distributed unit at the same time (i.e., in support of the multi-connectivity). Therefore, even when a certain connection fails, other connections can still provide the necessary communication function no matter during the process that the user equipment hands over from one master base station to another master base station or during the process that the user equipment switches between connections with the secondary base station distributed units. This can improve the communication reliability of the user equipment by effectively reducing the possibility of communication outage for the user equipment.

The above disclosure provides the detailed technical contents and inventive features thereof for the embodiments of the present invention, but such disclosure is not to limit the present invention. A person having ordinary skill in the art may proceed with a variety of modifications and replacements based on the disclosures and suggestions of the present invention as described above without departing from the characteristics thereof. Nevertheless, although such modifications and replacements are not fully disclosed in the above descriptions, they have substantially been covered in the following claims as appended.

What is claimed is:

1. A communication system in support of multi-connectivity, comprising:
a core network;
a user equipment, being configured to provide a measurement report;
a secondary base station, comprising a secondary base station centralized unit and at least one secondary base station distributed unit, wherein the secondary base station centralized unit connects to the at least one secondary base station distributed unit, and is configured to manage the at least one secondary base station distributed unit; and
a master base station connecting to the core network, the user equipment and the secondary base station centralized unit, being configured to coordinate, with the secondary base station centralized unit, how the user equipment connects with the at least one secondary base station distributed unit, according to the measurement report.

2. The communication system according to claim 1, wherein:
the master base station is an Evolved Universal Terrestrial Radio Access (E-UTRA) base station, and the secondary base station is a New Radio (NR) base station.

3. The communication system according to claim 1, wherein:
the core network is an Evolved Packet Core Network or a Next Generation Core Network.

4. The communication system according to claim 1, wherein:
the coordination between the master base station and the secondary base station centralized unit comprises at least one of:
adding one or more connections between the user equipment and the at least one secondary base station distributed unit;
releasing one or more connections between the user equipment and the at least one secondary base station distributed unit; and
adjusting one or more connections between the user equipment and the at least one secondary base station distributed unit.

5. The communication system according to claim 1, further comprising a source master base station, wherein:
the master base station coordinates, with the secondary base station centralized unit, how the user equipment connects with the at least one secondary base station distributed unit, according to the measurement report during a process that the user equipment hands over from the source master base station to the master base station.

6. The communication system according to claim 5, wherein:
the core network switches a path of the source master base station into a path of the master base station during the process that the user equipment hands over from the source master base station to the master base station.

7. A connecting method for use in a communication system in support of multi-connectivity, the communication system comprising a core network, a user equipment, a secondary base station and a master base station, the secondary base station comprising at least one secondary base station distributed unit and a secondary base station centralized unit that connects to the at least one secondary base station distributed unit and is configured to manage the at least one secondary base station distributed unit, the master base station connecting to the core network, the user equipment and the secondary base station centralized unit, the connecting method comprising:
providing a measurement report by the user equipment; and
the master base station coordinating, with the secondary base station centralized unit, how the user equipment connects with the at least one secondary base station distributed unit, according to the measurement report.

8. The connecting method according to claim 7, wherein:
the master base station is an Evolved Universal Terrestrial Radio Access (E-UTRA) base station, and the secondary base station is a New Radio (NR) base station.

9. The connecting method according to claim 7, wherein:
the core network is an Evolved Packet Core Network or a Next Generation Core Network.

10. The connecting method according to claim 7, wherein:
the coordination between the master base station and the secondary base station centralized unit comprises at least one of:
adding one or more connections between the user equipment and the at least one secondary base station distributed unit;
releasing one or more connections between the user equipment and the at least one secondary base station distributed unit; and
adjusting one or more connections between the user equipment and the at least one secondary base station distributed unit.

11. The connecting method according to claim 7, wherein:
the communication system further comprises a source master base station, and the master base station coordinates, with the secondary base station centralized unit, how the user equipment connects with the at least one secondary base station distributed unit, according to the measurement report during a process that the user equipment hands over from the source master base station to the master base station.

12. The connecting method according to claim 11, further comprising:
the core network switching a path of the source master base station into a path of the master base station during the process that the user equipment hands over from the source master base station to the master base station.
